(19) United States
(12) Patent Application Publication
(10) Pub. No.: US 2026/0099540 A1
(43) Pub. Date: Apr. 9, 2026

(54) AUTOMATING AUDIENCE MONITORING AND MUSIC MANAGEMENT

(71) Applicants: Sony Group Corporation, Tokyo (JP); Sony Pictures Entertainment Inc., Culver City, CA (US)

(72) Inventor: Justin Arnold Herman, Los Angeles, CA (US)

(21) Appl. No.: 18/910,899

(22) Filed: Oct. 9, 2024

(51) Int. Cl. G06F 16/635; G06V 20/52

(52) U.S. Cl. CPC G06F 16/635; G06V 20/52

(57) ABSTRACT

Automating audience monitoring and music management, including: monitoring an audience to determine demographics; selecting and playing songs based on the demographics; monitoring a response of the audience to the songs being played; and adjusting songs to play using artificial intelligence and based on the determined demographics and the response of the audience.

### BACKGROUND

### Field

The present disclosure relates to mixing and playing music for an audience, and more specifically to automating audience monitoring and music management.

### Background

Mixing and playing music for an audience of people to enjoy and dance to is a complicated and cumbersome task. For example, the disc jockey may need to select and play the music the people like so that they will stay, play, and party longer. However, the task may involve monitoring the audience while also managing the music.

### SUMMARY

The present disclosure provides for automating audience monitoring and music management.

In one implementation, a method for automating audience monitoring and music management is disclosed. The method includes: monitoring an audience to determine demographics; selecting and playing songs based on the demographics; monitoring a response of the audience to the songs being played; and adjusting songs to play using artificial intelligence (AI) and based on the determined demographics and the response of the audience.

In another implementation, a system for automating audience monitoring and music management is disclosed. The system includes: at least one camera pointed at an audience to produce image data; a visual experience (VX) engine to receive the image data from the at least one camera and to use the image data to determine demographics of the audience; and an artificial intelligence (AI) disc jockey (DJ) to receive output of the VX engine to determine songs which are popular with a group making up a plurality of the demographics of the audience, and to select and play a song based on the determined demographics and the popularity of the song.

In another implementation, a non-transitory computer-readable storage medium storing a computer program to automatically monitor audience and manage music is disclosed. The computer program includes executable instructions that cause a computer to: monitor an audience to determine demographics; select and play songs based on the demographics; monitor a response of the audience to the songs being played; and adjust songs to play using artificial intelligence (AI) and based on the determined demographics and the response of the audience.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a flow diagram of a method for automating audience monitoring and music management in accordance with one implementation of the present disclosure;

FIG. 2 is a block diagram of a system for automating audience monitoring and music management in accordance with one implementation of the present disclosure;

FIG. 3A is a representation of a computer system and a user in accordance with an implementation of the present disclosure; and

FIG. 3B is a functional block diagram illustrating the computer system hosting the music management application in accordance with an implementation of the present disclosure.

### DETAILED DESCRIPTION

As described above, mixing and playing music for an audience of people to enjoy and dance to may involve monitoring the audience while also managing the music.

Certain implementations of the present disclosure provide for automating the monitoring of the audience and the management of the music. After reading below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

In one implementation, the automation of the monitoring of the audience and the management of the music include the following:

(1) monitoring the audience to determine the demographics;

(2) selecting and playing songs based on the demographics;

(3) monitoring the audience response to the songs being played; and

(4) adjusting songs to play using artificial intelligence (AI) and based on the determined demographics and the response of the audience.

In one implementation, the audience monitoring (1) includes using a camera or multiple cameras pointed at the audience. The camera(s) may determine age, sex, and emotional engagement (e.g., positive or negative) to the music and others in the audience.

In one implementation, the selection and playing of songs (2) includes using an AI disc jockey (DJ) to make intelligent decision on song selection from a smart database of music based on current popularity or popularity with the detected demographics of the audience. For example, the AI DJ may determine that an average person who is 50 years old in 2023 and graduated from high school in 1991 likes late 80’s and early 90’s music.

In one implementation, the AI DJ using the smart database of music includes managing a large musical library and understanding a myriad of specifications of songs in the musical library. The smart database of music may also include a history of popularity. For example, the database may include top hits of the Billboard by year and month. The database may also include at least one of year of publication, year of peak popularity, artist, style, beats-per-minute (BPM), and other similar parameters such as bass drum heavy beat, snare heavy beat, and no strong beat.

In one implementation, the audience response monitoring (3) includes using an audience emotion tracking technology which may include a camera or multiple cameras pointed at the audience. The audience emotion tracking may determine age, sex, and emotional engagement (e.g., positive or negative) to the music being played and others in the audience. In another implementation, the audience monitoring includes a movement tracker, where more movement is considered desirable for upbeat songs, while coupling is expected for slow songs. The audience monitoring may also include linking the camera’s view with the beat of the song to quantify the song’s danceability with the audience.

In one implementation, the monitoring of the audience response (3) and the adjustment of the songs to play (4) include the AI DJ trying different types of music to appeal to the audience. The AI DJ may base its decisions on the past failure or success of songs previously played, changing demographics of the dance floor crowd, increasing or decreasing emotional engagement, and perceived success of the songs to “keep the beat.” In one example, the emotional engagement may be determined by certain metrics such as a total number of people in the room versus the number of people responding to the beat (e.g., dancing). The AI DJ continually attempts to keep the best engagement of the audience to the songs being played. In one implementation, the best engagement is determined by the number of engaged or dancing people, positive emotions of the audience, and success of the audience stepping with the beat of songs. In another implantation, the monitoring of the best engagement includes using facial and/or body movement trackers.

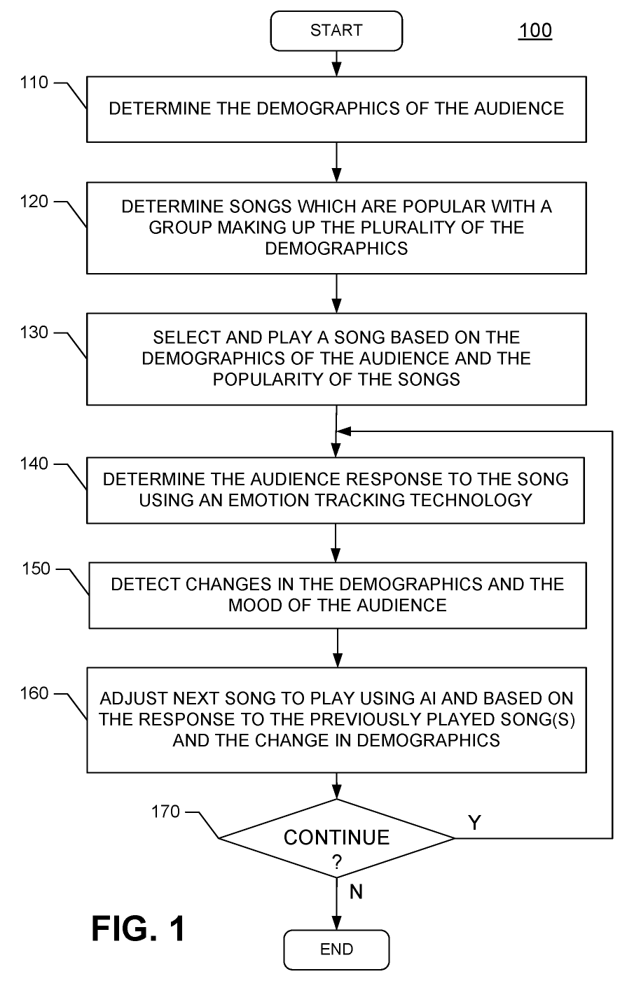

FIG. 1 is a flow diagram of a method 100 for automating audience monitoring and music management in accordance with one implementation of the present disclosure. In the illustrated implementation of FIG. 1, the demographics of the audience is determined, at step 110. In one implementation, the audience monitoring includes using a camera or multiple cameras pointed at the audience. The cameras may determine age, sex, and emotional engagement (e.g., positive or negative) to the music and others in the audience.

In the illustrated implementation of FIG. 1, songs which are popular with a group making up the plurality of the demographics of the audience are determined, at step 120. A song is then selected and played, at step 130, based on the determined demographics and the popularity of the song. In one implementation, the selection and playing of the song, at step 130, includes using the AI DJ to make intelligent decision on the song selection from a smart database of music based on current popularity or popularity with the detected demographics of the audience. For example, the AI DJ may determine that a person who is 50 years old in 2023 and graduated from high school in 1991 likes late 80’s and early 90’s music.

In one implementation, the selection and playing of the song, at step 130, using the smart database of music includes managing a large musical library and understanding a myriad of specifications of songs in the musical library. The smart database of music may also include a history of popularity. For example, the database may include top hits of the Billboard by year and month. The database may also include at least one of: year of publication, year of peak popularity, artist, style, beats-per-minute (BPM), bass drum heavy beat, snare heavy beat, no strong beat, and other similar parameters.

In the illustrated implementation of FIG. 1, the audience response is determined, at step 140, to the songs being played using an emotion tracking technology. In one implementation, the audience response determination, at step 140, includes using an audience emotion tracking technology to determine age, sex, and emotional engagement (e.g., positive or negative) to the music and others in the audience. In another implementation, the audience monitoring includes a movement tracker, where more movement is considered desirable for upbeat songs, while coupling is expected for slow songs. The audience monitoring may also include linking the camera’s view with the beat of the song to quantify the song’s danceability with the audience.

In the illustrated implementation of FIG. 1, changes in the demographics and the mood of the audience are detected, at step 150, and the next song to play is adjusted, at step 160, using AI and based on the response to the previously played song(s) and the changes in demographics of the audience. In one implementation, changes in the demographics and mood of the audience response and adjusting the songs to play include the AI DJ trying different types of music to appeal to the audience. The AI DJ may base its decisions on the past failure or success of songs previously played, changing demographics of the dance floor crowd, increasing or decreasing emotional engagement, and perceived success of the songs to “keep the beat.” In one example, the emotional engagement may be determined by certain metrics such as a total number of people in the room versus the number of people responding to the beat (e.g., dancing). The AI DJ continually attempts to keep the best engagement of the audience to the songs being played. In one implementation, the best engagement is determined by the number of engaged or dancing people, positive emotions of the audience, and success of the audience stepping with the beat of songs. In another implantation, the monitoring of the best engagement includes using facial and/or body movement trackers.

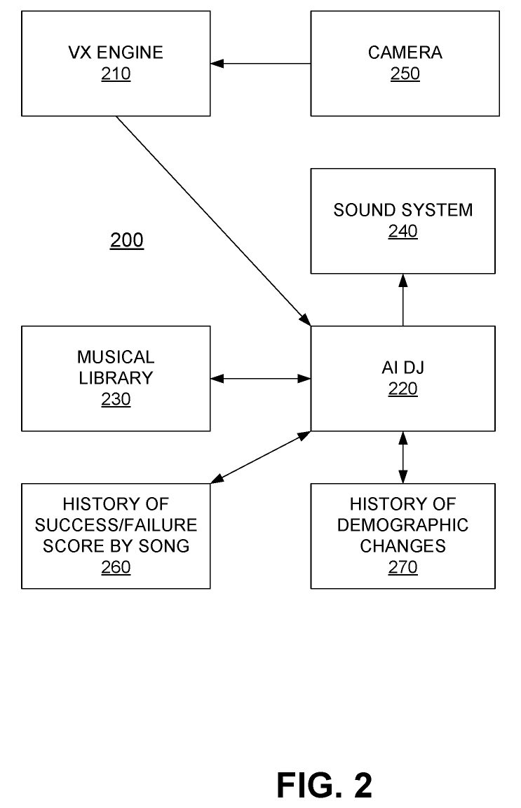

FIG. 2 is a block diagram of a system 200 for automating audience monitoring and music management in accordance with one implementation of the present disclosure. In the illustrated implementation of FIG. 2, the system 200 includes a visual experience (VX) engine 210, an AI DJ 220, a musical library 230, a sound system 240, and at least one camera 250. In one implementation, the system 200 also includes a history of success/failure score by song 260 and a history of demographic changes 270.

In one implementation, the at least one camera 250 is pointed at the audience. In one implementation, the VX engine 210 receives image data from the at least one camera 250 and uses the image data to determine the demographics of the audience. For example, the VX engine 210 may use an image processor to process the image data to determine the number of people in the audience and whether people are dancing or moving to the rhythm of the music. In another example, the VX engine 210 may use a facial recognition processor to process the image data to determine gender makeup, average age, emotional state (e.g., how engaged are people in the audience such as bored or happy), and other related characteristics of the people in the audience. The output of the VX engine 210 may then be sent to the AI DJ 220.

In one implementation, the AI DJ 220 receives the output of the VX engine 210 and uses the output to determine songs which are popular with a group making up the plurality of the demographics of the audience. The AI DJ 220 may also select and play a song based on the determined demographics and the popularity of the song. In one implementation, the AI DJ 220 makes intelligent decision on song selection from a smart database of music based on current popularity or popularity with the detected demographics of the audience. For example, the AI DJ 220 may determine that a person who is 50 years old in 2023 and graduated from high school in 1991 likes late 80’s and early 90’s music. In one implementation, the AI DJ 220 makes intelligent decision on song selection (i.e., what song to play next) using the song library 230, the history of success/failure score by song 260, and the history of demographic changes 270. For example, the AI DJ 220 may use the output of the VX engine 210 regarding the emotional state of the audience during the play of a song to drive the history of success/failure score 260 of the song.

In one implementation, the selection and playing of songs by the AI DJ 220 includes managing and understanding a myriad of specifications of songs in the musical library 230. The musical library 230 may also include a history of popularity such as top hits of the Billboard by year and month. The library 230 may also include at least one of: year of publication, year of peak popularity, artist, style, beats-per-minute (BPM), bass drum heavy beat, snare heavy beat, no strong beat, and other similar parameters.

In one implementation, the AI DJ 220 also determines the audience response to the songs being played using an emotion tracking technology. In one implementation, the AI DJ 220 uses the emotion tracking technology to determine age, sex, and emotional engagement (e.g., positive or negative) to the music and others in the audience. In another implementation, the AI DJ 220 uses a movement tracker, where more movement is considered desirable for upbeat songs, while coupling is expected for slow songs. The AI DJ 220 may also link the camera’s view with the beat of the song to quantify the song’s danceability with the audience.

In one implementation, the AI DJ 220 uses the history of demographic changes 270 and the emotion tracking technology to try different types of music to appeal to the audience. The AI DJ 220 may base its decisions on the past success/failure score of song 260 previously played, changing demographics of the dance floor crowd 260, increasing or decreasing emotional engagement, and perceived success of the songs to “keep the beat.” In one example, the emotional engagement may be determined by certain metrics such as a total number of people in the room versus the number of people responding to the beat (e.g., dancing). The AI DJ 220 continually attempts to keep the best engagement of the audience to the songs being played. In one implementation, the best engagement is determined by the number of engaged or dancing people, positive emotions of the audience, and success of the audience stepping with the beat of songs. In another implantation, the monitoring of the best engagement includes using facial and/or body movement trackers.

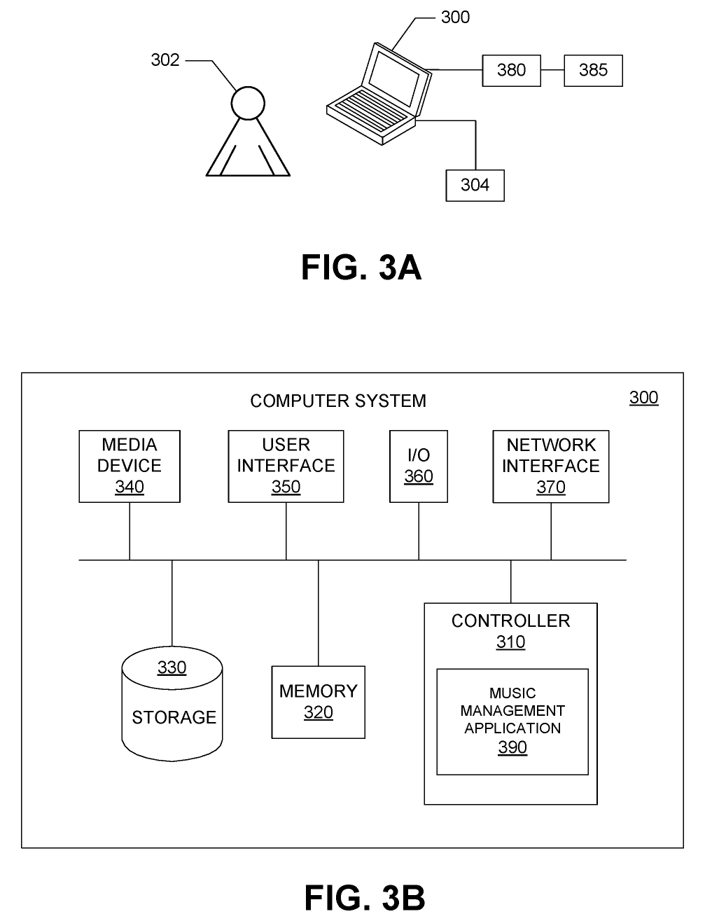

FIG. 3A is a representation of a computer system 300 and a user 302 in accordance with an implementation of the present disclosure. The user 302 uses the computer system 300 to implement an application 390 for automating audience monitoring and music management (i.e., the music management application) as illustrated and described with respect to the method 100 illustrated in FIG. 1 and the system 200 illustrated in FIG. 2.

The computer system 300 stores and executes the music management application 390 of FIG. 3B. In addition, the computer system 300 may be in communication with a software program 304. Software program 304 may include the software code for the music management application 390. Software program 304 may be loaded on an external medium such as a CD, DVD, or a storage drive, as will be explained further below.

Furthermore, computer system 300 may be connected to a network 380. The network 380 can be connected in various different architectures, for example, client-server architecture, a Peer-to-Peer network architecture, or other type of architectures. For example, network 380 can be in communication with a server 385 (e.g., a centralized system) that coordinates engines and data used within the music management application 390. Also, the network can be different types of networks. For example, the network 380 can be the Internet, a Local Area Network or any variations of Local Area Network, a Wide Area Network, a Metropolitan Area Network, an Intranet or Extranet, or a wireless network.

In one implementation, the AI DJ 220 enables a user to maintain an online account to keep track of metrics such as every use of songs and a history of success/failure of the songs with detected demographics. In one implementation, the AI DJ 220 connects to the server 385 through the network 380. Thus, when the AI DJ 220 is connected to the network 380, the user may share the metrics with the server 385. Otherwise, when the AI DJ 220 is not connected to the network 380, the metrics may be saved on a storage device within the system 200 and shared with the server 385 later when the AI DJ 220 is connected to the network 380.

In one implementation, with multiple users connecting to the server 385, the system 200 is enabled to collect data from the centralized system 385 to build the history of demographic changes 270 and the history of success/failure score by song 260. In one implementation, the system 200 in communication with the centralized system 385 tracks past sessions, locations, demographics, time of day, as well as other related metrics to improve the music management application 390 and share the improvements with other users of the AI DJ.

FIG. 3B is a functional block diagram illustrating the computer system 300 hosting the music management application 390 in accordance with an implementation of the present disclosure. A controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the music management application 390 with a software system, such as to enable the creation and configuration of engines and data extractors within the music management application 390. Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Storage 330 stores data either temporarily or for long periods of time for use by the other components of the computer system 300. For example, storage 330 stores data used by the music management application 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user of the computer system 300 and presenting information to the user 302. In one implementation, the user interface 350 includes a keyboard, a mouse, audio speakers, and a display. The controller 310 uses input from the user 302 to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 802.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

In one implementation, the system 200 is a system configured entirely with hardware including one or more digital signal processors (DSPs), general purpose microprocessors, application specific integrated circuits (ASICs), field programmable gate/logic arrays (FPGAs), or other equivalent integrated or discrete logic circuitry. In another implementation, the system 200 is configured with a combination of hardware and software.

In one particular implementation, a method for automating audience monitoring and music management is disclosed. The method includes: monitoring an audience to determine demographics; selecting and playing songs based on the demographics; monitoring a response of the audience to the songs being played; and adjusting songs to play using artificial intelligence (AI) and based on the determined demographics and the response of the audience.

In one implementation, monitoring the audience includes using at least one camera pointed at the audience to determine age, sex, and emotional engagement of the audience to the songs being played and others in the audience. In one implementation, selecting and playing of the songs includes using an AI disc jockey (DJ) to make intelligent decision on song selection from a smart database of songs based on current popularity or popularity with the detected demographics of the audience. In one implementation, using the AI DJ to make song selection from the smart database of songs includes managing a plurality of specifications of songs in a musical library. In one implementation, the smart database of songs includes a history of popularity of the songs. In one implementation, the smart database includes at least one of year of publication, year of peak popularity, artist, style, beats-per-minute (BPM), bass drum heavy beat, snare heavy beat, and no strong beat. In one implementation, monitoring the response of the audience includes using an audience emotion tracking technology to determine age, sex, and emotional engagement to the songs being played. In one implementation, monitoring the response of the audience includes using a movement tracker include linking a view of the at least one camera with beat of the songs being played to quantify danceability with the audience. In one implementation, adjusting the songs to play using AI includes trying different types of music to appeal to the audience by basing its decisions on the past failure or success of songs previously played, changing demographics of the dance floor crowd, increasing or decreasing emotional engagement, and perceived success of the songs to keep the beat.

In another particular implementation, a system for automating audience monitoring and music management is disclosed. The system includes: at least one camera pointed at an audience to produce image data; a visual experience (VX) engine to receive the image data from the at least one camera and to use the image data to determine demographics of the audience; and an artificial intelligence (AI) disc jockey (DJ) to receive output of the VX engine to determine songs which are popular with a group making up a plurality of the demographics of the audience, and to select and play a song based on the determined demographics and the popularity of the song.

In one implementation, the AI DJ makes intelligent decision on a song selection from a smart database of songs based on current popularity or popularity with the determined demographics of the audience. In one implementation, the AI DJ makes the intelligent decision using a music library, a history of success score by song, and a history of demographic changes. In one implementation, the AI DJ making the song selection from the smart database of songs includes the AI DJ managing a plurality of specifications of songs in a musical library. In one implementation, the smart database of songs includes a history of popularity of the songs. In one implementation, the smart database includes at least one of year of publication, year of peak popularity, artist, style, beats-per-minute (BPM), bass drum heavy beat, snare heavy beat, and no strong beat. In one implementation, the VX engine uses an image processor to process the image data to determine the number of people in the audience and whether people are dancing or moving to the rhythm of the music. In one implementation, the VX engine uses a facial recognition processor to process the image data to determine gender makeup, average age, emotional state of the audience.

In yet another implementation, a non-transitory computer-readable storage medium storing a computer program for automating audience monitoring and music management is disclosed. The computer program includes executable instructions that cause a computer to: monitor an audience to determine demographics; select and play songs based on the demographics; monitor a response of the audience to the songs being played; and adjust songs to play using artificial intelligence (AI) and based on the determined demographics and the response of the audience.

In one implementation, the executable instructions that cause the computer to monitor the audience include executable instructions that cause the computer to use at least one camera pointed at the audience to determine age, sex, and emotional engagement of the audience to the songs being played and others in the audience. In one implementation, the executable instructions that cause the computer to select and play the songs include executable instructions that cause the computer to use an AI disc jockey (DJ) to make intelligent decision on song selection from a smart database of songs based on current popularity or popularity with the detected demographics of the audience.

The descriptions herein of the disclosed implementations are provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

Various implementations of the present disclosure are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the present disclosure. In addition, the grouping of functions within a module or step is for ease of description. Specific functions can be moved from one module or step to another without departing from the present disclosure.

All features of each above-discussed example are not necessarily required in a particular implementation of the present disclosure. Further, it is to be understood that the description and drawings presented herein are representative of the subject matter that is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A method for automating audience monitoring and music management, the method comprising:
monitoring an audience to determine demographics;
selecting and playing songs based on the demographics;
monitoring a response of the audience to the songs being played; and
adjusting songs to play using artificial intelligence (AI) and based on the determined demographics and the response of the audience.

2. The method of claim 1, wherein monitoring the audience includes using at least one camera pointed at the audience to determine age, sex, and emotional engagement of the audience to the songs being played and others in the audience.

3. The method of claim 1, wherein selecting and playing of the songs includes using an AI disc jockey (DJ) to make intelligent decision on song selection from a smart database of songs based on current popularity or popularity with the detected demographics of the audience.

4. The method of claim 3, wherein using the AI DJ to make song selection from the smart database of songs includes managing a plurality of specifications of songs in a musical library.

5. The method of claim 4, wherein the smart database of songs includes a history of popularity of the songs.

6. The method of claim 4, wherein the smart database includes at least one of year of publication, year of peak popularity, artist, style, beats-per-minute (BPM), bass drum heavy beat, snare heavy beat, and no strong beat.

7. The method of claim 1, wherein monitoring the response of the audience includes using an audience emotion tracking technology to determine age, sex, and emotional engagement to the songs being played.

8. The method of claim 1, wherein monitoring the response of the audience includes using a movement tracker include linking a view of the at least one camera with beat of the songs being played to quantify danceability with the audience.

9. The method of claim 1, wherein adjusting the songs to play using AI includes trying different types of music to appeal to the audience by basing its decisions on the past failure or success of songs previously played, changing demographics of the dance floor crowd, increasing or decreasing emotional engagement, and perceived success of the songs to keep the beat.

10. A system for automating audience monitoring and music management, the system comprising:
at least one camera pointed at an audience to produce image data;
a visual experience (VX) engine to receive the image data from the at least one camera and to use the image data to determine demographics of the audience; and
an artificial intelligence (AI) disc jockey (DJ) to receive output of the VX engine to determine songs which are popular with a group making up a plurality of the demographics of the audience, and to select and play a song based on the determined demographics and the popularity of the song.

11. The system of claim 10, wherein the AI DJ makes intelligent decision on a song selection from a smart database of songs based on current popularity or popularity with the determined demographics of the audience.

12. The system of claim 11, wherein the AI DJ makes the intelligent decision using a music library, a history of success score by song, and a history of demographic changes.

13. The system of claim 11, wherein the AI DJ making the song selection from the smart database of songs includes the AI DJ managing a plurality of specifications of songs in a musical library.

14. The system of claim 13, wherein the smart database of songs includes a history of popularity of the songs.

15. The system of claim 13, wherein the smart database includes at least one of year of publication, year of peak popularity, artist, style, beats-per-minute (BPM), bass drum heavy beat, snare heavy beat, and no strong beat.

16. The system of claim 10, wherein the VX engine uses an image processor to process the image data to determine the number of people in the audience and whether people are dancing or moving to the rhythm of the music.

17. The system of claim 10, wherein the VX engine uses a facial recognition processor to process the image data to determine gender makeup, average age, emotional state of the audience.

18. A non-transitory computer-readable storage medium storing a computer program for automating audience monitoring and music management, the computer program comprising executable instructions that cause a computer to:
monitor an audience to determine demographics;
select and play songs based on the demographics;
monitor a response of the audience to the songs being played; and
adjust songs to play using artificial intelligence (AI) and based on the determined demographics and the response of the audience.

19. The computer-readable storage medium of claim 18, wherein the executable instructions that cause the computer to monitor the audience include
executable instructions that cause the computer to use at least one camera pointed at the audience to determine age, sex, and emotional engagement of the audience to the songs being played and others in the audience.

20. The computer-readable storage medium of claim 18, wherein the executable instructions that cause the computer to select and play the songs include
executable instructions that cause the computer to use an AI disc jockey (DJ) to make intelligent decision on song selection from a smart database of songs based on current popularity or popularity with the detected demographics of the audience.
